(19) United States
(12) Patent Application Publication
(10) Pub. No.: US 2012/0317518 A1
(43) Pub. Date: Dec. 13, 2012

(54) GENERATING TREEMAPS BASED ON GRAPHICAL SELECTIONS

(75) Inventors: Frank Wittig, Spiesen Elversberg (DE); Sabine Kirsch, Schiffweiler (DE)

(73) Assignee: SAP AG, Walldorf (DE)

(21) Appl. No.: 13/155,147

(22) Filed: Jun. 7, 2011

(51) Int. Cl. G06F 3/048

(52) U.S. Cl. 715/853

(57) ABSTRACT

Various example embodiments are disclosed. According to an example embodiment, non-transitory, computer-readable medium comprising instructions stored thereon. When executed by at least one processor, the instructions may be configured to cause the at least one processor to provide a treemap module and a tile module. The treemap module may be configured to generate treemaps within or in association with a first treemap within a first treemap graphical user interface (GUI). The treemaps may include sets of tiles, the tiles in the each set representing subsets of records in a database, based on filtered results obtained from application of groups of filters to the records. The tile module may be configured configured to process the selections of the sets of tiles in the first treemap.

### TECHNICAL FIELD

This description relates to visualizing data.

### BACKGROUND

The relationships between data may not be readily apparent to a user. Data records may have multiple attributes, and it may be difficult to determine features of subsets which have common values for certain attributes.

For example, a business user, who may not be an expert in statistics, may be interested in attributes of customers who have contributed revenue greater than a certain amount within a certain product category over a certain time period. The user may desire to examine subsets of the data which meet these criteria. However, it can be difficult to visualize these relationships within raw data, particularly for large datasets.

### SUMMARY

According to one general aspect, a non-transitory, computer-readable medium comprises instructions stored thereon. When executed by at least one processor, the instructions may be configured to cause the at least one processor to provide a treemap module and a tile module. The treemap module may be configured to generate a first treemap and a second treemap. The first treemap may be generated within a first treemap graphical user interface (GUI), the first treemap including a first set of tiles, the tiles in the first set representing subsets of records in a database, based on first filtered results obtained from application of a first group of filters to the records. The second treemap may be generated in association with the first treemap GUI, the second treemap including a second set of tiles, the tiles in the second set representing subsets of one or more of the subsets of records represented by one or more of the first set of tiles which are selected from the first treemap, based on second filtered results obtained from application of a second group of filters to the one or more of the subsets of records represented by the selected one or more of the first set of tiles. The tile module may be configured to process at least the selection of the one or more of the first set of tiles in the first treemap, and a selection of one or more of the second set of tiles in the second treemap.

According to another general aspect, a system may include at least one processor, and at least one memory device comprising computer-executable instructions stored thereon. When executed by the at least one processor, the instructions may be configured to cause the at least one processor to provide a treemap module and a tile module. The treemap module may be configured to generate a first treemap and a second treemap. The first treemap may be generated within a first treemap graphical user interface (GUI), the first treemap including a first set of tiles, the tiles in the first set representing subsets of records in a database, based on first filtered results obtained from application of a first group of filters to the records. The second treemap may be generated in association with the first treemap GUI, the second treemap including a second set of tiles, the tiles in the second set representing subsets of one or more of the subsets of records represented by one or more of the first set of tiles which are selected from the first treemap, based on second filtered results obtained from application of a second group of filters to the one or more of the subsets of records represented by the selected one or more of the first set of tiles. The tile module may be configured to process at least the selection of the one or more of the first set of tiles in the first treemap, and a selection of one or more of the second set of tiles in the second treemap.

According to another general aspect, a computer-implemented method may include generating, by a processor, a first treemap within a first treemap graphical user interface (GUI), the first treemap including a first set of tiles representing subsets of records in a database based on first filtered results obtained from an application of a first group of filters to the records, the first treemap GUI being configured to process a selection of one or more of the set of tiles. The method may also include receiving a tile selection of at least one tile from the first set of tiles from the first treemap via the first treemap GUI. The method may also include generating a second treemap within either the first treemap GUI or a second treemap GUI, the second treemap including a second set of tiles representing records based on second filtered results obtained from an application of a second group of filters to the records represented by the at least one selected tile.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram of a system for generating treemaps based on graphical selections by a user according to an example embodiment.

FIG. 2 is a flowchart illustrating example operations of the system of FIG. 1, according to an example embodiment.

FIG. 3 is a diagram of a filter graphical user interface (GUI) generated by the system of FIG. 1, according to an example embodiment.

FIG. 4 is a tree diagram of a data structure of the records filtered based on the selections by the user of the attributes in the filter GUI shown in FIG. 3 according to an example embodiment.

FIG. 5 is a diagram of a treemap GUI generated by the system of FIG. 1 according to an example embodiment.

FIG. 6 is a flowchart of a method performed in association with the system of FIG. 1 according to an example embodiment.

### DETAILED DESCRIPTION

Treemaps may assist in visualizing relationships between data records with multiple attributes. In example embodiments described herein, treemaps may be displays of nested graphical elements (which may be rectangles), that may be arranged in correspondence to hierarchical relations of data or records. The size of the nested graphical elements may correspond to a number of data records represented by the nested graphical element. Portions (or nested graphical elements) of a treemap, referred to herein as “tiles,” may represent multiple records with same values (or values which fall within a same predetermined range) for multiple (e.g., two or three) attributes. A user may wish to further examine the records represented by one or more tiles. Examining the records represented by one or more tiles may allow the user to learn more about the records which share certain traits or values for the attributes displayed in the treemap. For example, the user may desire to iteratively view treemaps of records represented by tiles selected from previous treemaps, using different attributes, or different ranges of values for the same attributes, as the previous treemaps. The user may thereby gain further insight into the data for records which have multiple attributes, which could be difficult to understand if the multiple attributes were displayed on a single treemap. The iterative filtering of the records on multiple treemaps may assist the user in understanding relationships between records in a data set which could not otherwise be understood by examining a single treemap.

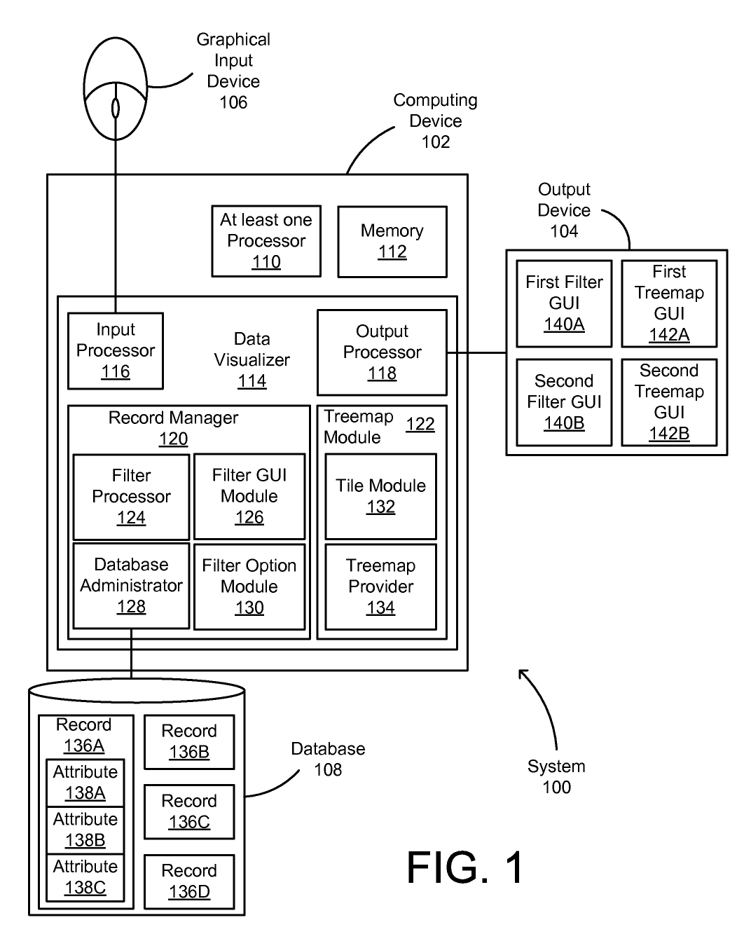

FIG. 1 is a diagram of a system 100 for generating treemaps based on graphical selections by a user according to an example embodiment. The system 100 may display data visually in a manner which is easy for a user, who may be untrained in statistics, to understand by visualizing the data records, and may facilitate an ability of the user to focus on interesting portions of the data.

For example, the system 100 may generate treemaps according to desired parameters or attributes. A user may select the desired parameters or attributes graphically, such as by using a mouse or trackball, and/or via a graphical user interface (GUI), such as by making selections via a combination of drop-down menus and/or buttons. After the system 100 has generated a treemap based on the selected parameters or attributes, a user may graphically select a portion(s) of the treemap, such as a tile(s) from the treemap, to focus on and select additional parameters. The user may select the portion(s) or tile(s) graphically, such as by using a mouse or trackpad to drag-and-drop or highlight the selected portion(s) or tile(s). The selected portion(s) or tile(s) may represent subsets of the data records, and may represent, for example, combinations of values or ranges of values for the selected parameters or attributes. The user may select certain tiles to find more information about the portions of the data, or subset of the data records, represented by the selected tiles.

The treemaps may be easy to interpret, and yield interesting insights into the data. For example, a user may select categories, such as order amount, product categories, and time period, based upon which to generate the treemap. The user may select a range for order amount, such as a total number of orders greater than or less than $500 (or some other form of currency such as Euros or Pounds), a plurality of product categories, such as electronics or household appliances, and time periods, such a calendar years.

In one example, after the system 100 has generated the treemap based on the selected attributes and categories, the user may select a tile from the treemap to focus on the records represented by the tile, such as customers with order amounts greater than $500, in the product category electronics, during the preceding year. These categories may be represented by a single tile in the treemap, and the user may select the single tile from within the treemap. While the user selects a single tile in this example, in other examples, the user may select multiple, but less than all, of the tiles in the treemap.

After the user has selected the tile(s) in the treemap, the system 100 may filter the records in the database to generate a subset of the records upon which further operations may be performed. The user may then select additional parameters to generate a second (or subsequent) treemap and investigate the additional attributes of the subset of data records, namely, those customers who had order amounts greater than $500 in the category of electronics during the past year. In the treemap, the screen areas of each tile may be proportional to the number of records or customers represented by that tile, or which have a same combination of values (or ranged of values) for the selected attributes, allowing the user to easily see which combinations of values for the selected attributes are most common in the dataset.

In an example implementation, the system 100 for generating the treemaps based on graphical selections may include a computing device 102. The computing device 102 may include any form of computer(s), such as a laptop computer, a desktop computer, a server, a tablet computer, or other computing device. The computing device 102 may both interface with the user directly and operate on the data, or may divide input, output, and processing tasks between multiple devices, such as by interacting with the user via a local client device, and performing other operations described herein at a remote host device or server, and communicating input and output signals from and to the user via a network such as the Internet. The computing device 102 may, for example, represent a combination of a local client device and a remote host device which perform(s) the functions described herein. The computing device 102 may represent any combination of the local client device and/or remote host device or server, or a single device which performs all of these functions.

The computing device 102 may perform the filtering functions, receive input, and provide output to enable the functions described herein. For example, the computing device 102 may provide output to an output device 104. The output device 104 may include a graphical or visual display such as, for example, a liquid crystal display (LCD), light-emitting diode (LED) display, flat screen display, plasma display, or cathode-ray tube (CRT), as non-limiting examples. The output device 104 may present graphical user interfaces (GUIs) to the user. The GUIs may, for example, display the allowable parameters or attributes to the user, allowing the user to select parameters or attributes upon which filtering will be performed, and may thereafter display the treemaps to the user which display the data records based on the filtering.

The computing device 102 may receive input from an input device such as a graphical input device 106. The graphical input device 106 may allow the user to graphically provide input to the computing device 102, such as by providing locations on the screen or output device 104 into which the user desires to place the input. The graphical input device 106 may, for example, allow the user to select directions to move a cursor. The graphical input device 106 may include, for example, a mouse or a track pad. The graphical input device 106 may allow the user to provide input to the computing device 102 without having to provide text entry. For example, the graphical input device 106 may allow the user to provide input into the computing device 102 based on locations on a screen of the output device 104 upon which the cursor controlled by the graphical input device 106 is located, and based on clicks or click releases by the user. In an example implemented according to the Java programming language, the computing device 102 may receive input from the graphical input device 106 via a MouseListener interface and/or a MouseMotionListener interface. Equivalent or similar interfaces or classes may be used in other programming languages.

The computing device 102 may also communicate with a database 108. While shown separately from the computing device 102, the database 108 may also be included within the computing device 102. The database 108 may include records with parameters or attributes upon which the computing device 102 performs filtering operations. The computing device 102 may utilize the records in the database 108 to present the allowable filters to the user, and to generate the treemaps to the user which provide the output based on the selected filters, parameters, or attributes.

For example, the computing device 102 may iteratively generate treemaps based on selections of parameters or attributes by the user. For example, the computing device 102 may generate a first treemap within the output device 104. The first treemap may include a first set of tiles which represent subsets of records in the database 108. Each of the subsets of records from the database 108 may represent combinations or first filtered results obtained from application of a first selected group of parameters or attributes to the records included in the database 108; the subset may correspond to a combination of values (or ranges of values) for the selected parameters or attributes.

The first treemap may include the first set of tiles, and allow the user to select one or more of the tiles from the treemap. The user may select the tile(s) via the graphical input device 106, such as via a mouse, MouseListener interface, and/or MouseMotionListener interface, or their equivalents. The computing device 102 may receive, via the graphical input device 106 in conjunction with the output device 104, a tile selection of at least one tile from the first set of tiles from the first treemap. The user may, for example, drag-and-drop one or more tiles from the first treemap off of the treemap and/or into a tile receiver, or may draw a rectangular outline or box around at least portions of the selected tiles within the treemap. These selected tiles may represent selections of subsets of the records in the database 108. The computing device 102 may create a subset of the records in the database 108 based on that subset.

After the user has selected the tile(s) representing a subset(s) of the records in the database 108, the computing device 102 may present additional parameter or attribute options to the user. The additional parameter or attribute options may be different from, or not include, the parameters or attributes used to generate the treemap from which the tile(s) was selected, and/or the additional parameter or attribute options may include narrower ranges of values for the parameters or attributes used to generate the treemap. The user may select the additional parameters or attributes based upon which the computing device 102 may generate a second treemap. The computing device 102 may present possible parameters to the user, based upon which the user may select parameters or attributes. The user may select the parameters or attributes for the second (or subsequent) treemap to learn more about the subset selected from the first (or subsequent) treemap. The computing device 102 may thereafter generate a second (or subsequent) treemap based on the selected parameters or attributes by performing filtering on the subset(s) of records.

In an example embodiment, the computing device 102 may include at least one processor 110 and a memory 112. The at least one processor 110 may include any type of processor, such as a general-purpose x86 family processor, a reduced instruction set computing (RISC) processor such as a MIPS processor or an ARM processor, or other processor capable of executing instructions and/or performing operations on data. The at least one processor 110 may also include multiple processors. The multiple processors may, for example, be capable of operating in parallel, such as by dividing the data in the database 108 into multiple subsets, with two or more of the processors performing the filtering on their respective subsets of the records in parallel, thereby achieving the filtering in a faster time than if only one processor was performing the filtering.

The computing device 102 may also include at least one memory device 112. The memory device 112 may include multiple memory devices such as registers, cache, DRAM, SRAM, and/or hard disks, and may include the database 108. The memory 112 may store instructions and data. The memory 112 may, for example, store the instructions to perform the functions and processes described herein, may store the inputs received from the user of the graphical input device 106, may store values resulting from operations performed on the records, may store changes to, or flags of, the records, and may store the records stored in the database 108.

The computing device 102 may also include a data visualizer 114. The data visualizer 114 may include software or instructions loaded on to the at least one processor 110 and/or memory 112 for execution, or may be a separate hardware device, according to example embodiments. The data visualizer 114 may perform any or all of the functions described herein. The data visualizer 114 may, for example, generate the GUI(s) which allow the user to graphically select the parameters or attributes based upon which filtering will be performed, and may generate the treemaps which will graphically present the data to the user. The data visualizer 114 may generate the GUI(s) and/or treemap(s) for display on the output device 104, and may send signals and/or data to the output device 104 enabling the output device 104 to display the GUI(s) and/or treemap(s). The data visualizer 114 may also receive and process the graphical input received from the user via the graphical input device 106. The modules of the data visualizer 114 described herein may be embodied in software, or may be embodied in separate hardware devices, according to example embodiments.

In an example embodiment, the data visualizer 114 may include an input processor 116. The input processor 116 may receive and/or process input received by the computing device 102 from the graphical input device 106, such as directions to move a cursor, and distances to move the cursor in those directions, and/or locations on the screen on which the user or mouse clicks and releases clicks. While the GUIs described herein generally respond to clicks and locations of movements on the display of the output device 104, the input processor 116 may also receive and process text input such as keyboard strokes.

The data visualizer 114 may also include an output processor 118. The output processor 118 may provide output to the output device 104, such as graphical output. The output processor 118 may, for example, generate filter GUIs based on which the user can select parameters or attributes to filter the records, and may generate the treemap GUIs which will be displayed by the output device 104. The output processor 118 may send data and/or signals to the output device 104 which cause the output device 104 to generate the filter GUIs and treemap GUIs, according to an example embodiment. While filter GUIs and treemap GUIs are described herein, the filter GUI(s) and treemap GUI(s) may be included in a single dialog box, and may be considered part of a single GUI, according to an example embodiment.

The data visualizer 114 may also include a record manager 120. The record manager 120 may operate in communication with the database 108. The record manager 120 may, for example, perform functions on, or perform functions or based on, the records included in the database 108. For example, the record manager 120 may include a filter processor 124. The filter processor 124 may filter the records in the database 108, or subsets thereof, based on the parameters or attributes selected by the user from the filter GUI. The filter processor 124 may, for example, filter the records at multiple levels, such as in a tree-shaped hierarchy, to generate combinations and sub-combinations of the values of the attributes of the records, allowing the records to be filtered into the combinations and sub-combinations for a presentation to the user in a treemap.

The record manager 120 may also include a filter GUI module 126. The filter GUI module 126 may generate the filter GUIs for the user based on attributes of the records in the database. The filter GUIs may present parameter or attribute options, such as selections of parameters or options and selections of ranges or values within the selected parameters or options, to the user for generation of a treemap. For example, the records in the database 108 may have multiple attributes, any or all of which may be selected by the user for generation of the treemap; however, the user may desire to select which attributes of the records will be used to generate the treemap.

The filter GUI module 126 may act in cooperation with a filter option module 130 of the record manager 120. The filter option module 130 may determine the available attributes of the records in the database 108. The filter option module 130 may inspect the records stored in the database 108 to determine what attributes are available for filtering the records. The filter option module 130 may determine that all of the attributes of the records in the database 108 are available for selection, or may determine that only attributes which have not previously been used in generation of a treemap are available for selection, or may determine that attributes which have previously been used for generation of a treemap are available for selection, but only if narrower ranges of values are selected, according to example embodiments.

The filter option module 130 may provide the available attributes, and/or ranges of values thereof, to the filter GUI module 126, and the filter GUI module 126 may generate the filter GUI with the available attributes (and/or ranges of values thereof) for selection of attributes and/or ranges by the user. The filter option module 130 may, for example, provide ranges of the attributes to the filter GUI module 126 which are equally spaced between a minimum and a maximum of the values of the attributes, or may provide ranges based on other techniques, such as ranges which have equal numbers of records having values within the ranges, or combinations thereof.

The record manager 120 may also include a database administrator 128. The database administrator 128 may operate in communication with the database 108. The database administrator 128 may, for example, receive the records and/or attributes from the database 108. The database administrator 128 may also provide instructions to the database 108. The database administrator 128 may, for example, provide flags to the database 108 indicating groups or subsets which should include the records based on filter options which have been selected, tiles which have been selected, and/or based on operations performed by the filter processor 124. The database administrator 128 may also provide instructions to the database 108 to alter the structure of the records stored in the database 108 to more easily retrieve the data based on the filtering parameters selected at the filter GUI and/or based on tiles selected at the treemap GUI.

The database 108 may include multiple records 136A, 136B, 136C, 136D (referred to hereinafter in the plural as records 136). Example records 136 are shown in the database 108 of FIG. 1 for illustrative purposes only. While four records 136 are shown in the example database 108 of FIG. 1, many more than four records 136 will typically be included in the database 108. The records 136 may each include multiple attributes 138A, 138B, 138C.

The attributes shown in FIG. 1 include 138A, 138B, 138C (referred to hereinafter in the plural as attributes 138). While the example records 136 shown in FIG. 1 include three attributes 138, the records 136 may include any number of attributes 138. The attributes 138 may include nominal attributes, the values of which may identify a type or kind, may include ordinal attributes, the values of which may be used for ranking or sequencing, and/or may include numerical or quantitative attributes, the values of which may have meaningful mathematical operations such as addition, subtraction, multiplication, and division performed on them. The nominal attributes may be filtered only into subsets with the same value for the nominal attribute, whereas ordinal or numerical attributes may also be filtered into ranges, according to an example embodiment.

The data visualizer 114 may also include a treemap module 122. The treemap module 122 may generate treemaps and treemaps GUIs. The treemap module 122 may also process input into the treemap GUIs from a user. The treemap module 122 may, for example, include a treemap provider 134 which generates the treemaps and treemap GUIs, described below. The treemap module 122 may also include a tile module 132 which processes selections by the user of tiles in the treemaps.

The output device 104, as discussed above, may display filter GUIs and treemap GUIs to the user. While the filter GUIs and treemap GUIs are described separately, the filter interface and treemap(s) may be included in a single dialog box or GUI, according to an example embodiment.

In the example shown in FIG. 1, the output device 104 may include a first filter GUI 140A and a second filter GUI 140B (the output device 104 may also present additional filter GUIs 140 to the user as the user iteratively selects tiles from the treemaps and selects additional filtering options to be performed on the subsets of records represented by the selected tiles). While shown separately, the first and second filter GUIs 140A, 140B may or may not be included on the screen of the output device 104 at a same time. The first filter GUI 140A and second filter GUI 140B may be shown on the output device 104 at different times presenting different filtering options, or may be a single filter GUI which may present different filter options to the user at different times. The filter GUIs 140A, 140B may provide filter options to the user based on the attributes 138 of the records 136 included in the database 108 which were determined by the filter option module 130. The filter GUIs 140A, 140B may allow the user to select options for filtering, such as selecting different attributes 138, and/or different ranges of values for the attributes 138, based upon which to generate the treemaps.

The output device 104 may also include the first and second treemap GUIs 142A, 142B. The treemap GUIs 142A, 142B may have been generated by the treemap provider 134 of the treemap module 122. While shown separately on the example output device 104 of FIG. 1, the first and second treemap GUIs 142A, 142B may be displayed by the output device 104 at a same time, or may be displayed at different times. In an example embodiment, multiple treemaps may replace each other on the same treemap GUI 142 (the treemap GUIs 142A, 142B may be referred collectively as treemap GUI 142). Multiple treemaps may be displayed on the same treemap GUI 142 at different times. Or, the same GUI or dialog box may be used both to present filter options to a user and to present the treemaps to the user, and the filter GUIs 140 and treemap GUIs 142 may be embodied in a single GUI.

The treemap GUI 142 may allow a user to interact with the tiles in the treemap. The treemap GUI 142 may, for example, display detailed records of a particular tile over which the user hovers the cursor, may allow the user to highlight multiple tiles in the treemap, and/or may allow the user to drag a particular tile off of the treemap GUI 142, thereby selecting the tile for additional filtering of the records represented by the tile. While two filter GUIs 140 and two treemap GUIs 142 are shown in FIG. 1, any number of filter GUIs and treemap GUIs may be presented to the user. The user may iteratively select different tiles, and select different filtering parameters based upon which to generate additional treemaps, to learn more about the relationships and/or shared attribute values between the records 136 included in the database 108.

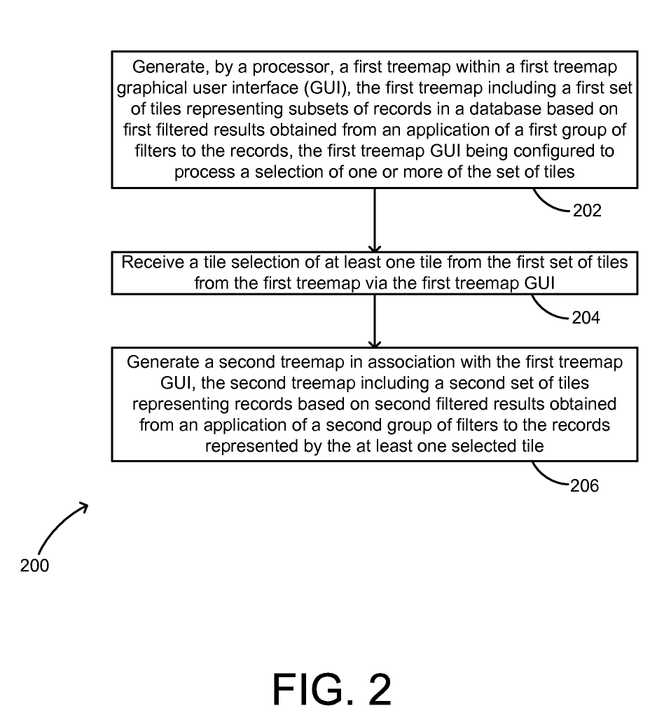

FIG. 2 is a flowchart illustrating example operations of the system of FIG. 1. The example operations may be included in a method 200. The method 200 may include generating, by a processor 110, a first treemap within a first treemap graphical user interface (GUI) 142A (202). For example, the treemap provider 134 of the treemap module 122 of the data visualizer 114 of the computing device 102 may be configured to generate the first treemap GUI 142A. The first treemap may include a first set of tiles representing subsets of records 136 in a database 108 based on first filtered results obtained from an application of a first group of filters to the records 136. The first treemap GUI 142A may be configured to process a selection of one or more of the set of tiles.

The method 200 may also include receiving a tile selection of at least one tile from the first set of tiles from the first treemap via the first treemap GUI 142A (204). For example, the input processor 116 of the data visualizer 114 of the computing device, in cooperation with the first filter GUI 140A of the output device 104 and the tile module 132 of the treemap module 122 of the data visualizer 114, may be configured to receive and process the tile selection of the at least one tile. The method 200 may also include generating a second treemap within either the first treemap GUI 142A or a second treemap GUI 142B (206); the second treemap GUI 142B may also be considered to be generated in association with the first treemap GUI 142A. For example, the treemap provider 134 of the treemap module 122 of the data visualizer 114 of the computing device 102 may be configured to generate the second treemap GUI 142B. The second treemap may include a second set of tiles representing records 136 based on second filtered results obtained from an application of a second group of filters to the records 136 represented by the at least one selected tile.

In an example embodiment, the first group of filters may be based on a first filter selection from a first filter GUI 140A, and the second group of filters may be based on a second filter selection from either the first filter GUI 140A or a second filter GUI 140B (or in association with the first filter GUI 140A).

In an example embodiment, the processor 110 may receive the first tile selection via the first treemap GUI 142A via a graphical input device 106 such as a mouse input.

In an example embodiment, the processor 110 may receive the first tile selection via the first treemap GUI 142A via a MouseListener interface or a MouseMotionListener interface when implemented in the Java programming language, or via an equivalent interface when implemented in another programming language.

The first treemap may divide the first set of tiles into vertical columns based on a first filter from the first group of filters. Each of the vertical columns may include all the tiles with a same value for the first attribute based upon which the first treemap is generated.

The method 200 may further include generating a first filter GUI 140A, the first filter user GUI 140A comprising first filter options based on attributes of the records 136 in the database 108, and receiving, via the first filter GUI 140A, a selection of the first group of filters from the first filter options. In an example embodiment, the method 200 may further include generating a second filter GUI 140B, the second filter user GUI 140B comprising second filter options based on attributes 138 of the records 136 represented by the at least one selected tile, and receiving, via the second filter GUI 140B, a selection of the second group of filters from the second filter options. In an example embodiment, the first filter GUI 140A may include at least two dropdown menus including selections of the attributes 138 of the records 136 in the database 108, and the second filter GUI 140B may include at least two dropdown menus including selections of the attributes 138 of the records 136 represented by the at least one selected tile.

The method 200 may further include receiving a preselection input from the user. The preselection input may include hovering the cursor over a tile(s) of the treemap, or dragging or drawing a rectangle over a portion of the treemap including at least portions of multiple tiles. The preselection input may indicate a preselected area of the treemap including a plurality of the tiles included in the first treemap. The method 200 may also include changing a color of the preselected area. The changing of the color may be based on the indicated area of the treemap, and may allow the user to preview which tile(s) will be selected for additional filtering, according to an example embodiment.

Receiving the tile selection may include the user highlighting an area of the first treemap. The highlighted area may include at least portions of the selected first set of tiles. The user may highlight the area by hovering the cursor over the area, or by dragging or drawing a rectangle over the area. The highlighted area may serve as a preview of which records 136 will be selected for further filtering. The user may finalize the tile selection by dragging and dropping the highlighted area from the first treemap into another portion of a screen, such as by moving the mouse and unclicking the mouse.

Receiving the tile selection may include the user dragging and dropping the selected at least one tile from the first treemap onto a tile receiver. The tile receiver may be an object in another part of the screen or display of the output device 104. The user may, for example, click the mouse button with the cursor on the area of the display occupied by the tile, drag the tile off of the area of the screen occupied by the treemap by guiding the cursor with the mouse while holding the mouse button, and release the mouse button when the tile is at least partially, or fully located in the part of the display occupied by the tile receiver.

A size of the tiles in the first treemap may proportional to a number of records 136 represented by each tile, and a size of the tiles in the second treemap may be proportional to a number of records 136 represented by each tile. For example, each pixel in the tile may represent a certain number of records 136. The number of records 136 represented by each pixel or size unit in the tile may be scaled so that the total area of all tiles in the treemap takes up an appropriate area of the display.

The tiles within the first set of tiles may be distinguished from each other by colors, and the tiles within the second set of tiles may be distinguished from each other by colors. Some of the tiles within a set may be the same color, but a sufficient number of colors may be used to distinguish the tiles within the set from each other. For example, the tiles sharing the same value or range of values for the first parameter or attribute may be the same color, but tiles with different values or ranges of values for the first parameter or attribute may be different colors. Or, the tiles within a column of a treemap which have same values or ranges of values for the first parameter or attribute may be different colors, distinguishing the tiles in each column, and relying on the column demarcations to distinguish tiles in different columns from each other.

The tiles within the first set of tiles may be separated from each other by first treemap borders, the borders having a color which is different than a color of the first set of tiles, and the tiles within the second set of tiles may be separated from each other by second treemap borders, the borders having a color which is different than a color of the second set of tiles. Within each treemap, for example, each of the tiles may be separated from each other by borders which are a same color, such as black or white, throughout the treemap.

The first treemap may include text indicating the first filtered results for each of the first set of tiles, and the second treemap may include text indicating the second filtered results for each of the second set of tiles. The text may, for example, be included in each of the tiles. Each of the tiles may, for example, include the value, or range of values, for the records 136 represented by the respective tile for the parameters or attributes 138 according to which the records 136 were filtered to generate the respective treemap.

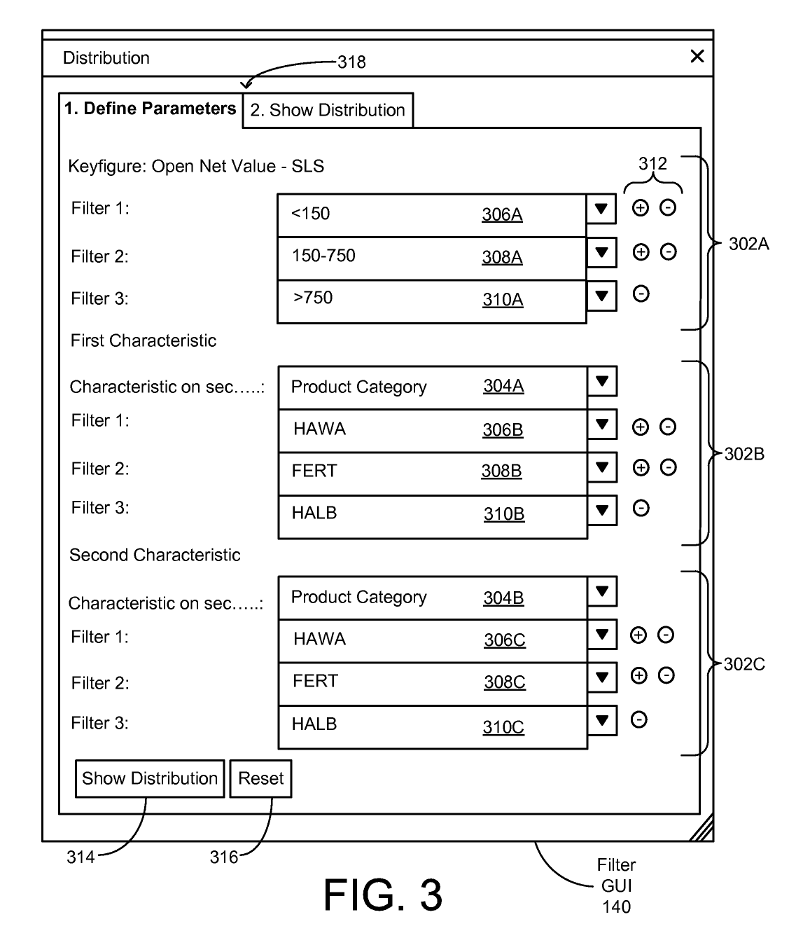

FIG. 3 is a diagram of a filter graphical user interface (GUI) 140 generated by the system 100 of FIG. 1, according to an example embodiment. The filter GUI 140 may allow the user to select attributes 138 of the records 136 based upon which to filter the records 136 and generate a treemap. The filter GUI 140 may also allow the user to select the ranges or categories within the attributes 138 upon which to generate sub-combinations or filters for the treemap. In an example embodiment, each attribute 138 selected by the user may have at least two categories or ranges of values into which the filter processor 124 of the computing device 102 will filter the records 136 to generate the treemap. The filter GUI 140 may, for example, allow a user to select a maximum of three attributes 138 based upon which to filter the records 136. The maximum of three attributes 136 may ensure that the resulting treemap is easy for the user to understand, and may also limit the complexity of the filtering operations which the computing device 102 will have to perform based on the selected attributes 138.

The filter GUI 140 may have two or three attribute interfaces 302A, 302B, 302C. The attribute interfaces 302A, 302B, 302C of the filter GUI 140 may receive and process graphical input from the user. The graphical input from the user received by the attribute interfaces 302A, 302B, 302C may include selections of attributes 138 and categories or ranges of values for the selected attributes 138. The filter GUI 140 may, for example, provide drop-down menus and/or buttons into which the user may provide input. The user may, for example, provide graphical input via the graphical input device 106 by selecting attributes 138 via drop-down menus and/or buttons, selecting categories within the attributes 138 via drop-down menus and/or buttons, and/or selecting ranges for values of the attributes via drop-down menus and/or buttons.

In the example shown in FIG. 3, the filter GUI 140 may include attribute drop-down menus 304A, 304B. The attribute drop-down menus 304A, 304B may be drop-down menus which allow the user to select among the attributes 138 for filtering and may present the available attributes 138 to the user. The attributes 138 may be included in the drop-down menus 304A, 304B based on the filter option module's 130 determination that the computing device 102 should present these attributes 138 to the user as options for filtering.

The filter GUI 140 may also include range or category drop-down menus 306A, 308A, 310A, 306B, 308B, 310B, 306C, 308C, 310C. The range or category drop-down menus 306A, 308A, 310A, 306B, 308B, 310B, 306C, 308C, 310C may present, to the user, ranges or categories within the selected attributes 138 by which the records 136 will be filtered into subsets or combinations. The user may select the ranges or categories within the selected categories that the user wishes to examine within the subsequent treemap. The categories of the attributes 138 may be provided by the filter option module 130.

The filter GUI 140 may also include increment buttons 312. The increment buttons 312 may allow the user to change the increments of the ranges within the range or category drop-down menus 306A, 308A, 310A, 306B, 308B, 310B, 306C, 308C, 310C when the range or category drop-down menus 306A, 308A, 310A, 306B, 308B, 310B, 306C, 308C, 310C are presenting ranges to the user, or may scroll through categories within the drop-down menus 306A, 308A, 310A, 306B, 308B, 310B, 306C, 308C, 310C. The filter GUI 140 may propose initial ranges or categories for the values of the attributes 138, which may have been determined by the filter option module 130, such as equidistant ranges or ranges which each have equal numbers of records 136.

In the example shown in FIG. 3, each attribute interface 302A, 302B, 302C has three range or category drop-down menus 306A, 308A, 310A, 306B, 308B, 310B, 306C, 308C, 310C, allowing for three value ranges or categories for their respective attribute 138; however, any number, such as two or more to provide meaningful filtering, of range or category drop-down menus 306A, 308A, 310A, 306B, 308B, 310B, 306C, 308C, 310C may be included the attribute interfaces 302A, 302B, 302C. In an example embodiment, the user may select or customize the number of range or category drop-down menus 306A, 308A, 310A, 306B, 308B, 310B, 306C, 308C, 310C for each attribute interface 302A, 302B, 302C, allowing the user to customize how many ranges or categories to filter the records 136 into when generating the treemap.

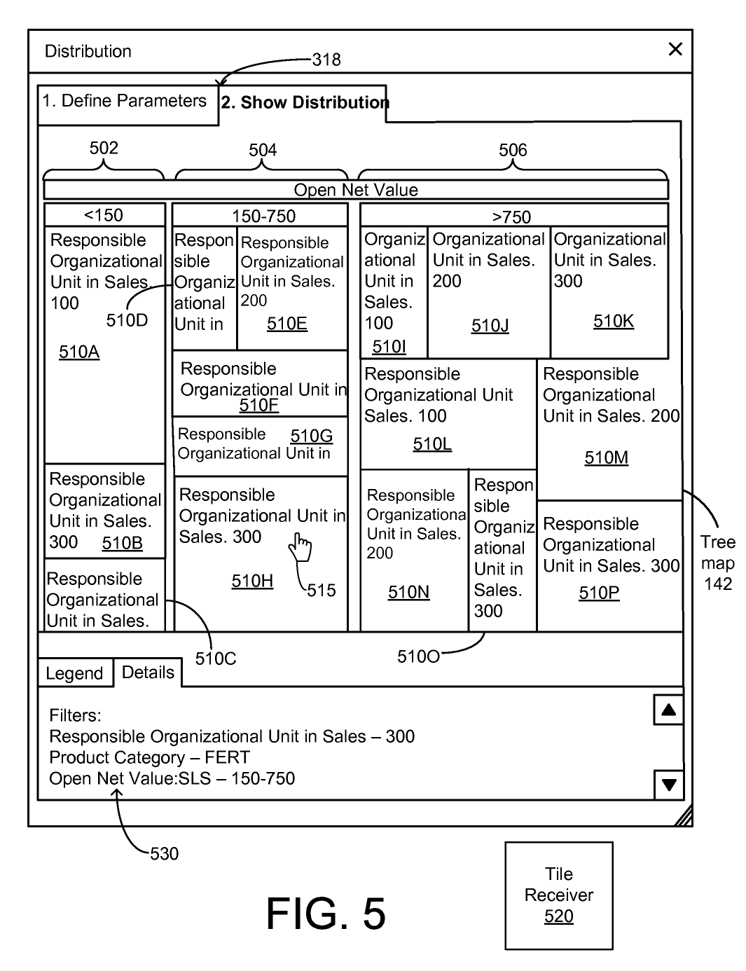

In the example shown in FIG. 3, the user has selected, as filtering attributes, the value of sales as the first attribute, and product category as first and second attributes. The first attribute to be selected may be significant, as it may drive the generation of columns of the treemap, as will be discussed further with respect to FIG. 5. In this example, the user has selected, or the filter GUI 140 has selected for the user, the Open Net Value of sales as the first attribute. The user has also selected the ranges of the sales by which the filtering should be performed. The ranges selected by the user in this example are less than 150, between 150-750 and greater than 750. The user may have specified the ranges using the increment buttons 312, increasing or decreasing the boundaries of the ranges to his or her desired values.

In this example, the user has selected, in the attribute drop-down menu 304A of the attribute interface 302B, the second attribute, Product Category. The user has also selected the product categories, which may be nominal values, in the range or category drop-down menus 306B, 308B, 310B, namely, HAWA, FERT, and HALB. In this example, the user has desired to examine these three product categories HAWA, FERT, and HALB in the resulting treemap. In this example, the user may not yet have selected the third category in the attribute interface 302C.

The filter GUI 140 may also include a show distribution button 314. The show distribution button 314 may allow the user to click on the show distribution button 314 and thereby provide the computing device 102 with an instruction to generate the treemap. The filter GUI 140 may also include a reset button 316, the clicking of which may generate an instruction the computing device 102 to erase the selected attributes within the attribute interfaces 302A, 302B, and/or to undo any filtering that has been performed, and return to the original database 108 with all of the records 136 included in the database 108. The filter GUI 140 may also include a GUI status indicator 318. The GUI status indicator 318 may indicate whether a combined filter and treemap GUI 140, 142 is in a filter state, as shown in FIG. 3 with the words, “Define Parameters” legible or bolded and the words, “Show Distribution” faded, or, as will be seen in FIG. 5, a treemap state, with the words, “Define Parameters” faded, and the words, “Show Distribution” legible or bolded.

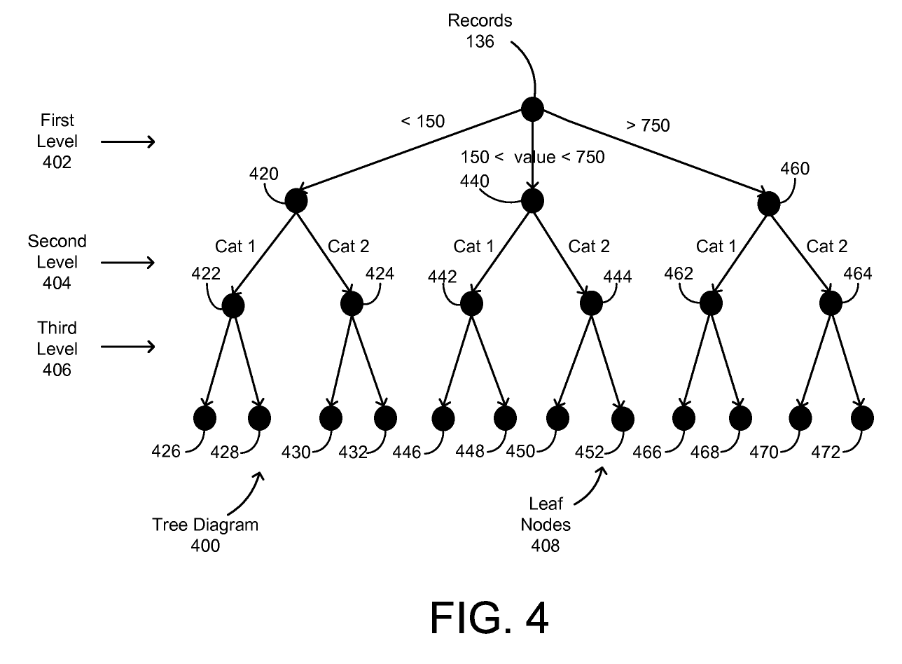

FIG. 4 is a tree diagram 400 of a data structure of the records 136 filtered based on the selections by the user of the attributes 138 in the filter GUI 140 shown in FIG. 3 according to an example embodiment. This tree diagram 400 is a schematic of database operations performed by the filter processor 124, and may not be visible to the user. In this example, the records 136 have been filtered, such as by the filter processor 124 shown and described with reference to FIG. 1, according to the attributes 138 selected by the user in the filter GUI 140. At each level in the tree diagram 400, the nodes represent the records filtered at the level. For example, the records 136 may include three nodes 420, 440, 460 filtered at a first level 402 based on the first attribute, which in the example of FIG. 3 was the value of the purchases. The data structure 400 may also include six nodes 422, 424, 442, 444, 462, 464 filtered at a second level 404 based on the second attribute selected by the user. The second attribute may include the product category selected in the filter GUI 140 shown in FIG. 3. The data structure may also include twelve nodes, 426, 428, 430, 432, 446, 448, 450, 452, 466, 468, 470, 472 at a third level 406 filtered according to a third attribute selected by the user. While the example tree diagram 400 shown in FIG. 4 shows filtering into three categories at the first level 402, two categories at the second level 404, and two categories at the third level 406, any number of categories may exist for filtering at each level 402, 404, 406, based on the categories selected in the filter GUI 140.

For example, of the tree diagram 400 corresponds to selections similar to those made in the filter GUI 140 of FIG. 3, the node 420 may represent the subset of the records 136 which all have a first range of value for the first selected attribute, such as less than $150 for the total sales value, which was the first range selected for the first attribute selected in the attribute interface 302A of the filter GUI 140. The node 422 may include all of subset of the records 136 which have less than $150 for the total sales value, and which have HAWA for the product category. The node 426 may include the subset of the records 136 which have less than $150 for the total sales value, and which have HAWA for the product category, and which have a first selected category for a third selected attribute, such as the previous year for the date of sales.

The other nodes in the data structure 400 may represent other combinations of values in similar fashion to the node 426. The leaf nodes 408, which may include nodes 426, 428, 430, 432, 446, 448, 450, 452, 466, 468, 470, 472 at the bottom of the tree diagram 400, may represent the final combinations or subsets of the filtering performed based on the selections in the filter GUI 140. The leaf nodes 408 may correspond to tiles in the treemap. The leaf nodes 408 may each represent a number of records 136 stored in the database 108. The computing device 102 may store the number of records 136 represented by each of the leaf nodes 408. The number of records represented by each of the leaf nodes 408 may be used by the computing device 402 to determine a size of the tiles in the treemap. The tiles in the treemap may have a size proportional to the number of records represented by that corresponding leaf node 408.

FIG. 5 is a diagram of the treemap GUI 142 generated by the system 100 of FIG. 1 according to an example embodiment. As discussed above, tiles 510A, 510B, 510C, 510D, 510E, 510F, 510G, 510H, 510I, 510J, 510K, 510L, 510M, 510N, 510O, 510P (referred to collectively herein as tiles 510) in a treemap 500 included in the treemap GUI 142 may have a size based on the number of records 136 represented by the leaf node 408 (shown in FIG. 4) corresponding to the respective tile 510. For example, each of the tiles 510 included in the treemap 500 may correspond to a leaf node 408, and may include a number of pixels based on the number of records 136 represented by the respective tile 510. While not shown in FIG. 5, in an example embodiment, each of the tiles 510 may include text indicating a number of records 136 represented by the tile, i.e., the number of records 136 in the subset of the corresponding leaf node 408.

The tiles 510 in the treemap 500 of the treemap GUI 142 may be rectangular; however, other shapes of tiles 510 may also be included in the treemap GUI 142. As discussed above, the treemap GUI 142 may have columns corresponding to the first attribute selected in the filter GUI 140. The columns may be vertical representations of all the tiles 510 included which represent records 136 which have a same value for the first attribute 136. For example, in the example shown in FIG. 3, the first attribute selected was the Open Net Value. Based on the selection of the Open Net Value as the first attribute upon which to perform the filtering, the example treemap GUI 142 shown in FIG. 5 has three columns 502, 504, 506, representing three ranges of value for the Open Net Value, namely less than 150, between 150 and 750, and greater than 750. The three columns each include multiple tiles 510 with the values for the first attribute. The three columns 502, 504, 506 in the treemap GUI 142 may, for example, correspond to the three nodes, 420, 440, 460 upon which filtering was performed according to the first attribute 138 at the first level 402 in the example shown in FIG. 4. The tiles 510 within each of the columns 502, 504, 506 may represent different values for attributes 138 other than the Open Net Value.

In an example embodiment, the treemap GUI 142 may be combined with the filter GUI 140. As discussed above, the combined filter and treemap GUI 140, 142 may indicate whether the filters or treemap are shown by highlighting or shading, “Define Parameters,” or, “Show Distribution.” The user may return the combined GUI 140, 142 to the filter mode shown in FIG. 3 by selecting a tile(s) 510 for further filtering, or by clicking a button to toggle between modes. For example, the combined filter and treemap GUI 140, 142 may include buttons or tabs such as “Define parameters” and Show Distribution“. The buttons or tabs 318 may allow the user to alternate between the filter GUI 140 and the treemap GUI 142. The filter GUI 140 and the treemap GUI 142 may thereby be included in a single dialog box included on the screen of the output device 104.

When interacting with the treemap GUI 142, the user may hover the cursor 515 over certain tiles 510, such as tile 510H, in the treemap 500 of the treemap GUI 142. Hovering over tiles 510 in the treemap GUI 142 may cause the treemap GUI 142 to provide additional details about the records 136 represented by the hovered-over tile 510. The treemap GUI 142 may, for example, highlight the hovered-over tile 510H such as by changing the color (or shade of color) of the hovered-over tile 510H. The treemap GUI 142 may also provide additional details about the records 136 represented by the hovered-over tile 510H. For example, the treemap GUI 142 may provide or display the values (or range of values) for each of the filters or attributes 138 applied to generate the hovered-over tile 510H.

In the example shown in FIG. 5, a detail box 530 of the treemap GUI 142 indicates the details 520 of the hovered-over tile 510H as having the value ‘300’ for the responsible organizational unit in sales (the third selected attribute 138), FERT as the product category (the second selected attribute 138), and 150-750 as the range for the Open Net Value (the first selected attribute 138).

The treemap GUI 142 may allow the user to select tiles 510 by highlighting tiles 510 with a rectangular drawing box, or by dragging-and-dropping the selected tiles. For example, the treemap GUI 142 may allow a user to select a tile 510 by dragging the selected tile 510 and dropping the selected tile 510 on a location of the screen of the output device 104 which is off of or outside the treemap GUI 142, or by dropping the selected tile into a tile receiver 520. If the user selects multiple tiles 510 by highlighted or enclosing the tiles 510 within a shape such as a rectangular drawings box, the selected tiles 510 may be contiguous, according to an example embodiment.

The computing device 102 may store which tiles 510 have been selected, and may store the records 136 associated with or represented by the selected tiles 510 for further filtering based on subsequent attributes 138 selected by the user. In an example embodiment, the user may iteratively select attributes 138 by which to perform filtering on the records 136 represented by the selected tiles 510. The user may iteratively instruct the system 100 to filter the records 136 represented by the selected tiles 510 by returning to the filter GUI 140 and selecting additional attributes 138 or parameters based upon which to filter the records 136 represented by the selected tiles 510, and generate an additional treemap 500 based on the selected filters, and select a tile(s) 510 representing records 136 for further filtering.

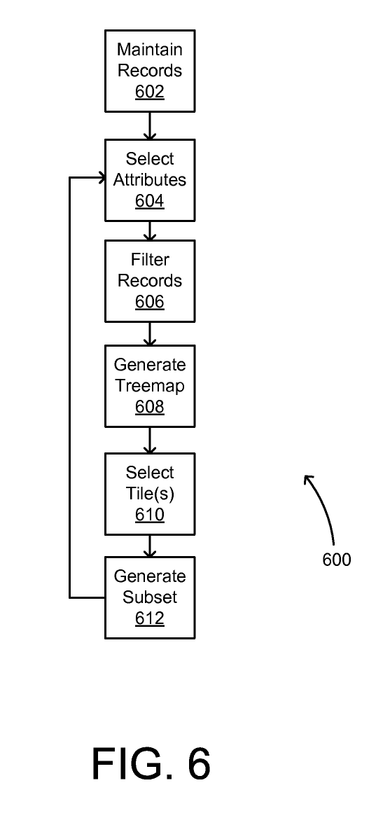

FIG. 6 is a flowchart of a method 600 performed in association with the system 100 of FIG. 1 according to an example embodiment. In this example, the method 600 may include maintaining records 136 in a database (602). For example, the computing device 102 and/or database 108 may maintain the records 136. The maintained records 136 may include multiple attributes 138. The computing device 102 may present the attributes 138 to the user for filtering of the records 136. The computing device 102 may, for example, present attributes 138 which the filter option module 130 determined were available for filtering of the records 136. The computing device 102 may present the attributes 138 to the user within the filter GUI 140.

The user may select attributes (604). The user may select multiple attributes 138 of the records 136, such as two or three attributes 138. The computing device 102 may thereafter filter the records 136 based on the selected attributes 138 (606). The data structure or relationship between the records 136 after the filtering may resemble the tree diagram 400 shown in FIG. 4.

After the computing device 102 has filtered the records 136, the computing device 102 may generate a treemap 500 (608). The system 100 may present or display the generated treemap 500 to the user. The system 100 may present the generated treemap 500 within the treemap GUI 142. The user may select one or more tiles 510 from the treemap 500 (610). The selected tile(s) 510 may represent records 136 in the database 108 based on combinations of values of the attributes 138 for the selected filters.

After the user has selected a tile 510, the computing device 102 may generate a subset of the records 136 in the database 108 based on the records 136 represented by the selected tile(s) 510. The computing device may iteratively filter the records 136, present treemaps 500 to the user based on the filtering, and generate a subset of the records 136 based on the selected tile 510, until the user has acquired all the information he or she desires. The computing device 102 may, after generating the subset (612), present attributes 138 to the user, based upon which the user may again select attributes (604). The selection of attributes 138 (604), filtering of records 136 (606), generating of a treemap 500 (608), selection of tiles 510 (610) and generation of a subset (612), may be performed iteratively as many times as the user desires to develop greater insight into the records 136.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A non-transitory, computer-readable medium comprising instructions stored thereon that, when executed by at least one processor, are configured to cause the at least one processor to provide:
a treemap module configured to generate
a first treemap within a first treemap graphical user interface (GUI), the first treemap including a first set of tiles, the tiles in the first set representing subsets of records in a database, based on first filtered results obtained from application of a first group of filters to the records; and
at least a second treemap in association with the first treemap GUI, the second treemap including a second set of tiles, the tiles in the second set representing subsets of one or more of the subsets of records represented by one or more of the first set of tiles which are selected from the first treemap, based on second filtered results obtained from application of a second group of filters to the one or more of the subsets of records represented by the selected one or more of the first set of tiles; and
a tile module configured to process at least
the selection of the one or more of the first set of tiles in the first treemap; and.
a selection of one or more of the second set of tiles in the second treemap.

2. The computer-readable medium of claim 1, wherein the treemap module is configured to:
generate the tiles in the first set with sizes proportional to the number of records in the subsets that they respectively represent; and
generate the tiles in the second set with sizes proportional to the number of records in the subsets that they respectively represent.

3. The computer-readable medium of claim 1, wherein the treemap module is configured to divide the first set of tiles into vertical columns based on a first filter from the first group of filters.

4. The computer-readable medium of claim 1, wherein the treemap module is configured to indicate values for a subset of records represented by a tile in which a cursor is located.

5. The computer-readable medium of claim 1, wherein the tile module is configured to receive the selections of the first and second sets of tiles via a mouse input.

6. The computer-readable medium of claim 1, wherein the tile module is configured to receive the selections of the first and second sets of tiles via a MouseListener interface or a MouseMotionListener interface.

7. The computer-readable medium of claim 1, wherein the tile module is configured to process the selection of the one or more of the first set of tiles in the first treemap by a user dragging the one or more of the first set of tiles off of the first GUI.

8. The computer-readable medium of claim 1, further configured to cause the at least one processor to provide:
a filter GUI module configured to receive and process
a first filter selection of the first group of filters; and
a second filter selection of the second group of filters.

9. The computer-readable medium of claim 1, further configured to cause the at least one processor to provide:
a filter option module configured to determine
first filter options based on attributes of the records in the database; and
second filter options based on attributes of the records represented by the one or more of the first set of tiles which are selected from the first treemap; and
a filter GUI module configured to receive and process:
a first filter selection of the first group of filters, the first group of filters being selected from the first filter options; and
a second filter selection of the second group of filters, the second group of filters being selected from the second filter options.

10. The computer-readable medium of claim 1, further configured to cause the at least one processor to provide:
a filter option module configured to determine
first filter options based on attributes of the records in the database; and
second filter options based on attributes of the records represented by the one or more of the first set of tiles which are selected from the first treemap; and
a filter GUI module configured to receive and process
a first filter selection of the first group of filters, the first group of filters being selected from the first filter options via two or more drop-down menus; and
a second filter selection of the second group of filters, the second group of filters being selected from the second filter options via two or more drop-down menus.

11. A system comprising:
at least one processor; and
at least one memory device comprising computer-executable instructions stored thereon that, when executed by the at least one processor, are configured to cause the at least one processor to provide at least
a treemap module configured to generate
a first treemap within a first treemap graphical user interface (GUI), the first treemap including a first set of tiles, the tiles in the first set representing subsets of records in a database, based on first filtered results obtained from application of a first group of filters to the records; and
at least a second treemap in association with the first treemap GUI, the second treemap including a second set of tiles, the tiles in the second set representing subsets of one or more of the subsets of records represented by one or more of the first set of tiles which are selected from the first treemap, based on second filtered results obtained from application of a second group of filters to the one or more of the subsets of records represented by the selected one or more of the first set of tiles; and
a tile module configured to process at least:
the selection of the one or more of the first set of tiles in the first treemap; and.
a selection of one or more of the second set of tiles in the second treemap.

12. The system of claim 11, wherein the treemap module is configured to:
generate the tiles in the first set with sizes proportional to the number of records in the subsets that they respectively represent; and
generate the tiles in the second set with sizes proportional to the number of records in the subsets that they respectively represent.

13. The system of claim 11, wherein the treemap module is configured to divide the first set of tiles into vertical columns based on a first filter from the first group of filters.

14. The system of claim 11, wherein the treemap module is configured to indicate values for a subset of records represented by a tile in which a cursor is located.

15. The system of claim 11, wherein the tile module is configured to receive the selections of the first and second sets of tiles via a mouse input.

16. A computer-implemented method comprising:
generating, by a processor, a first treemap within a first treemap graphical user interface (GUI), the first treemap including a first set of tiles representing subsets of records in a database based on first filtered results obtained from an application of a first group of filters to the records, the first treemap GUI being configured to process a selection of one or more of the set of tiles;
receiving a tile selection of at least one tile from the first set of tiles from the first treemap via the first treemap GUI;
generating a second treemap within either the first treemap GUI or a second treemap GUI, the second treemap including a second set of tiles representing records based on second filtered results obtained from an application of a second group of filters to the records represented by the at least one selected tile.

17. The method of claim 16, wherein:
generating the first treemap includes generating the first treemap within the first treemap GUI, the first treemap including the first set of tiles representing subsets of records in the database based on the first filtered results obtained from the application of the first group of filters to the records, the first treemap GUI being configured to process a selection of one or more of the set of tiles, the first group of filters being based on a first filter selection from a first filter GUI; and
the generating the second treemap comprises generating the second treemap in association with the first treemap GUI the second treemap including the second set of tiles representing records based on the second filtered results obtained from the application of the second group of filters to the records represented by the at least one selected tile, the second group of filters being based on a second filter selection from either the first filter GUI or a second filter GUI.

18. The method of claim 16, wherein the receiving the tile selection includes receiving the tile selection of at least one tile from the first set of tiles from the first treemap via the first treemap GUI via a mouse input.

19. The method of claim 16, wherein the receiving the tile selection includes receiving the tile selection of at least one tile from the first set of tiles from the first treemap via the first treemap GUI via a MouseListener interface or a MouseMotionListener interface.

20. The method of claim 16, wherein the generating the first treemap comprises generating the first treemap within the first treemap GUI, the first treemap including the first set of tiles representing subsets of records in the database based on the first filtered results obtained from the application of the first group of filters to the records, the first treemap GUI being configured to process the selection of one or more of the set of tiles, the first treemap dividing the first set of tiles into vertical columns based on a first filter from the first group of filters.
